(19) United States
(12) Patent Application Publication
(10) Pub. No.: US 2009/0127403 A1
(43) Pub. Date: May 21, 2009

(54) LIFT FLAP CARRIER SYSTEM

(75) Inventors: Juan PEREZ-SANCHEZ, Bad Aibling (DE); Gerd Schuhmacher, Heimstetten (DE); Markus Pauly, Bruckmuehl (DE); Siegfried Bechtle, Muenchen (DE); Josef Mendler, Bad Feilnbach (DE); Dieter Frank, Kolbermoor (DE)

Correspondence Address: GREENBLUM & BERNSTEIN, P.L.C., 1950 ROLAND CLARKE PLACE, RESTON, VA, 20191, US

(73) Assignee: EADS DEUTSCHLAND GmbH, Ottobrunn (DE)

(21) Appl. No.: 12/248,617

(22) Filed: Oct. 9, 2008

(30) Foreign Application Priority Data
Oct. 10, 2007 (DE) 102007048449.8-22

(51) Int. Cl. B64C 21/00

(52) U.S. Cl. 244/213; 244/131

(57) ABSTRACT

Device for carrying lift flaps arranged on the wings of an aircraft and a wing. The device includes a carrier with a U-shaped profile, a covering plate positionable over an open side of the U-shaped profile, and a fairing housing formed in an aerodynamic manner and at least in part by the carrier. The instant abstract is neither intended to define the invention disclosed in this specification nor intended to limit the scope of the invention in any way.

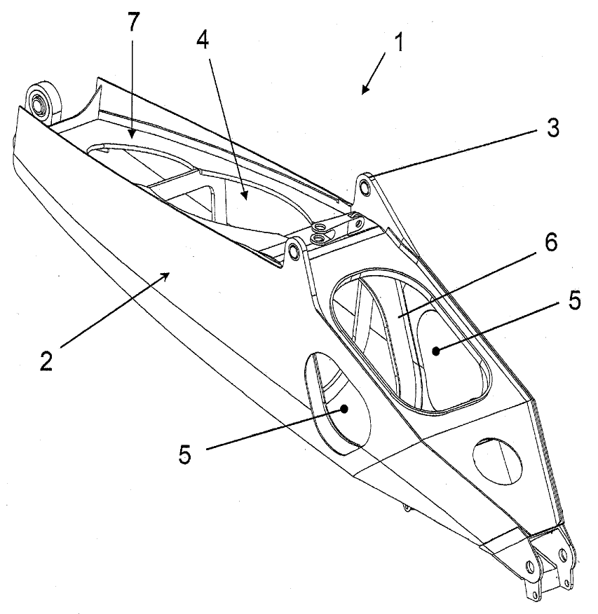

### CROSS-REFERENCE TO RELATED APPLICATIONS

The present application claims priority under 35 U.S.C. § 119 of German Patent Application No. 10 2007 048 449.8 filed Oct. 10, 2007, the disclosure of which is expressly incorporated by reference herein in its entirety.

### BACKGROUND OF THE INVENTION

1. Field of the Invention

The invention relates to a device for carrying lift flaps arranged on the wings of an aircraft.

2. Discussion of Background Information

A wing with extendable aerodynamic lift flaps and a drive unit encased by a fairing housing is known from German Patent Application No. DE 10 2005 016 639 A1.

A lift-flap mechanism for adjusting a lift flap assigned to a wing and having a plurality of steering lever arrangements is known from European Patent No. EP 1 404 573 B 1.

A carrying or guiding device for a landing flap of the type specified is known, for example, from German Patent Application No. DE 41 07 556 C1, which has a carrier with an essentially U-shaped profile. The carrier comprises cast aluminum and has load-bearing rails for guiding a carriage that is connected to the landing flap. To ensure the necessary stiffness, reinforcement elements in the form of a torsion stiffening box, a tension strength band and a cross member are provided. During takeoff and during landing the landing flaps are extended so that a greater uplift is created. Naturally enormous stresses occur thereby on the landing flaps and consequently on the carrying or guiding devices, which is why they must have particularly high stiffness values. The movement of the landing flap is usually transferred to the landing flaps via a drive screw having a corresponding transmission and attached to the wing spar box. A transmission is thereby attached to the carrying or guiding device, which transmission displaces and pivots the landing flap, for example, via a lever. High torques are thereby introduced into the carrier, which must not negatively impact its structure. Also in the case of the landing flap being jammed, the carrier of the carrying or guiding device must not be destroyed. Usually therefore carriers of this type comprise steel, aluminum or titanium with a corresponding number of reinforcement elements. This results in a device with relatively high weight, which should be avoided in aircraft technology due to the resulting higher fuel consumption, as well as higher production and assembly expenditure.

An improved variant of a carrier is described by European Patent No. EP 1 438 230 B1. This U-shaped carrier is produced from fiber-reinforced plastic. A covering plate is assigned to the carrier, with which covering plate the open side of the carrier is covered. This covering plate and further elements present on the carrier for connection to other components and for reinforcing the carrier are likewise produced from fiber-reinforced plastic.

The U-shaped carrier is attached by its underside to the wing, so that the open side of the carrier is facing away from the wing. To carry out maintenance work in the interior of a carrier attached to the wing, a plurality of work steps must be carried out in order to ensure accessibility. Also, e.g., the fairing housing surrounding the carrier must be dismantled.

### SUMMARY OF EMBODIMENTS OF THE INVENTION

Embodiments of the invention provide a device for carrying lift flaps that avoid the above-referenced disadvantages of the prior art.

The device includes a carrier with a U-shaped profile and a covering plate for the open side of the carrier. The device also includes a fairing housing embodied or formed in an aerodynamic manner. The carrier forms at least a part of the fairing housing.

Weight is saved because the carrier itself forms a part of the fairing housing. Furthermore, the carrier can be attached much more simply and quicker than is possible in the conventional devices of the prior art. Further advantages of embodiments of the invention include a better use of space, since the carrier assumes the shape of the fairing, and the higher stiffness of the carrier.

Expediently the open side of the U-shaped carrier faces in the direction of the wing. In contrast to the embodiment of European Patent No. EP 1 438 230 B1, in which the open side of the carrier is embodied or arranged facing away from the wing, a better inspectability of the interior and a better maintenance of the carrier is thus possible with the carrier according to the embodiments of the invention.

According to a further feature of the invention, the carrier has stiffening structures. These stiffening structures can be arranged on the carrier wall in the form of profiles with Z-shaped, U-shaped or I-shaped or similarly shaped cross sections. Furthermore a truss-like stiffening structure is also possible.

The carrier according to the invention and the covering plate according to the invention and any stiffening structures can be produced from carbon fiber-reinforced plastic according to a special embodiment of the invention. Thus, the weight can be reduced and the number of individual parts of the carrier device can be reduced through the integral construction method with the use of plastic. The production of the device according to embodiments of the invention of fiber-reinforced plastic can be carried out the known manner by the arrangement of fabric layers impregnated with resin, so-called “prepregs,” on a mold and curing the arrangement in an autoclave under heat and pressure. The device according to the invention can also be produced expediently in VAP construction according to the resin infusion method. This method is known, e.g., from German Patent Application No. DE 199 15 083 C1.

Of course, a mixed construction method is also possible in which reinforcement elements are produced from metal and carbon fiber-reinforced plastic.

Expediently openings can be provided in the fairing for the possible integration of drives of the flap guide mechanism. Further weight can be saved thereby.

The shell shape thereby corresponds in predetermined areas to the aerodynamic shape of the fairing housing.

Embodiments of the invention are directed to a device for carrying lift flaps arranged on the wings of an aircraft. The device includes a carrier with a U-shaped profile, a covering plate positionable over an open side of the U-shaped profile, and a fairing housing formed in an aerodynamic manner and at least in part by the carrier.

In accordance with embodiments of the invention, the device can further include an attachment device structured and arranged to attach the carrier to the wing.

According to other embodiments of the present invention, holes can be formed in the carrier.

In accordance with other features, the carrier includes stiffening structures. Further, at least one of the covering plate and the stiffening structures may be connectable to the carrier via adhesive connection. In addition to the adhesive connection, connecting elements may be structured and arranged to connect the at least one of the covering plate and the stiffening structures to the carrier, and the connection elements can include at least one of rivets and screws. At least one of the carrier, the covering plate, and the stiffening structures may include carbon fiber-reinforced plastic, at least one of the carrier, the covering plate, and the stiffening structures may be formed of carbon fiber-reinforced plastic, at least one of the carrier, the covering plate, and the stiffening structures comprises may be formed by a resin infusion method at least one of the carrier, the covering plate, and the stiffening structures may be formed from a prepreg, and/or at least one of the carrier, the covering plate, and the stiffening structures may be formed according to a prepreg method. Further, at least one of the carrier, the covering plate, and the stiffening structures can be formed in an autoclave.

Embodiments of the invention are directed to a device for carrying lift flaps of an aircraft. The device includes a carrier having a U-shaped profile portion at least in part structured and arranged as a fairing housing, and a covering plate coupleable to an open side of the U-shaped profile.

According to features of the embodiments, the carrier can further include stiffening structures to increase rigidity of the carrier. Moreover, at least one of the carrier, the covering plate, and the stiffening structures can be formed by at least one of carbon fiber-reinforced plastic, a resin infusion method, and a prepreg method.

In accordance with other embodiments of the instant invention, an attachment device may be structured and arranged to connect the carrier to a wing of the aircraft.

Moreover, the device may further include an opening structured and arranged to receive linkage for extending lift flaps of the aircraft.

Embodiments of the invention are directed to a wing for an aircraft. The wing includes a carrier having a U-shaped profile portion at least in part structured and arranged as a fairing housing, and the carrier is coupleable to a portion of the wing and being further structured and arranged to support a lift flap. A covering plate is coupleable to an open side of the U-shaped profile, and the U-shaped profile is arranged to position the open side to face the portion of the wing.

In accordance with still yet other embodiments of the present invention, the carrier can be one of formed of metal with a plurality of holes to reduce weight or formed of a non-metal material.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

The FIGURE shows a shell-shaped carrier.

### DETAILED DESCRIPTION OF EMBODIMENTS OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The FIGURE shows a carrier 1 according to the invention with a U-shaped profile.

Carrier 1 has a closed aerodynamic shell shape in an area 2 located upstream. This area of carrier 1 is thus suitable for taking over the function of the fairing housing. The aerodynamic fairing customarily used in the prior art, which, as the only component surrounding the carrier structure, can thus be omitted.

Shell-shaped carrier 1 that thus conforms to the fairing has integrated wing connecting lugs 3 by which the construction can be attached to an underside of the wing of an aircraft (not shown).

The essentially U-shaped shell shape has an opening 4 facing in the direction of the underside of the wing. Opening 4 can be closed with a covering plate 7, which is embodied or formed to be not completely closed or with lightening holes. U-shaped carrier structure 1 has openings 5 in order to be able, when necessary, to integrate in an interior of carrier 1 a flap guide mechanism or drive (not shown).

The construction further has an essentially truss-shaped interior reinforcement 6, which makes it possible to realize a construction method optimized in terms of weight.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A device for carrying lift flaps arranged on the wings of an aircraft, comprising:
a carrier with a U-shaped profile;
a covering plate positionable over an open side of the U-shaped profile; and
a fairing housing formed in an aerodynamic manner and at least in part by the carrier.

2. The device in accordance with claim 1, further comprising an attachment device structured and arranged to attach the carrier to the wing.

3. The device in accordance with claim 1, wherein holes are formed in the carrier.

4. The device in accordance with claim 1, wherein the carrier includes stiffening structures.

5. The device in accordance with claim 4, wherein at least one of the covering plate and the stiffening structures are connectable to the carrier via adhesive connection.

6. The device in accordance with claim 5, further comprising, in addition to the adhesive connection, connecting elements structured and arranged to connect the at least one of the covering plate and the stiffening structures to the carrier.

7. The device in accordance with claim 6, wherein the connection elements comprise at least one of rivets and screws.

8. The device in accordance with claim 5, wherein at least one of the carrier, the covering plate, and the stiffening structures comprises carbon fiber-reinforced plastic.

9. The device in accordance with claim 5, wherein at least one of the carrier, the covering plate, and the stiffening structures is formed of carbon fiber-reinforced plastic.

10. The device in accordance with claim 5, wherein at least one of the carrier, the covering plate, and the stiffening structures comprises is formed by a resin infusion method.

11. The device in accordance with claim 5, wherein at least one of the carrier, the covering plate, and the stiffening structures is formed from a prepreg.

12. The device in accordance with claim 5, wherein the at least one of the carrier, the covering plate, and the stiffening structures is formed according to a prepreg method.

13. The device in accordance with claim 12, wherein the at least one of the carrier, the covering plate, and the stiffening structures is formed in an autoclave.

14. A device for carrying lift flaps of an aircraft, comprising:
a carrier having a U-shaped profile portion at least in part structured and arranged as a fairing housing; and
a covering plate coupleable to an open side of the U-shaped profile.

15. The device in accordance with claim 14, wherein the carrier further includes stiffening structures to increase rigidity of the carrier.

16. The device in accordance with claim 15, wherein at least one of the carrier, the covering plate, and the stiffening structures is formed by at least one of carbon fiber-reinforced plastic, a resin infusion method, and a prepreg method.

17. The device in accordance with claim 14, further comprising an attachment device structured and arranged to connect the carrier to a wing of the aircraft.

18. The device in accordance with claim 14, further comprising an opening structured and arranged to receive linkage for extending lift flaps of the aircraft.

19. A wing for an aircraft, comprising:
a carrier having a U-shaped profile portion at least in part structured and arranged as a fairing housing;
the carrier being coupleable to a portion of the wing and being further structured and arranged to support a lift flap; and
a covering plate coupleable to an open side of the U-shaped profile,
wherein the U-shaped profile is arranged to position the open side to face the portion of the wing.

20. The wing in accordance with claim 19, wherein the carrier is one of formed of metal with a plurality of holes to reduce weight or formed of a non-metal material.
